(19) United States
(12) Patent Application Publication
(10) Pub. No.: US 2026/0341842 A1
(43) Pub. Date: Oct. 29, 2026

(54) SYSTEMS AND METHODS FOR COOLANT CONNECTION FOR EXTERNAL LEAK MANAGEMENT FOR BATTERY PACKS

(71) Applicant: LG Energy Solution, Ltd., Seoul (KR)

(72) Inventors: Jin Woo Park, Oakland Township, MI (US); Heekook Yang, Sterling Heights, MI (US); Juil Yum, Ann Arbor, MI (US)

(73) Assignee: LG Energy Solution, Ltd., Seoul (KR)

(21) Appl. No.: 19/314,827

(22) Filed: Aug. 29, 2025

Related U.S. Application Data
(60) Provisional application No. 63/794,900, filed on Apr. 25, 2025.

(51) Int. Cl. H01M 10/6568; H01M 10/613; H01M 10/625; H01M 10/6554; H01M 50/271

(52) U.S. Cl. CPC H01M 10/6568; H01M 10/613; H01M 10/625; H01M 10/6554; H01M 50/271

(57) ABSTRACT

A system includes: a battery pack enclosure to enclose a battery system; a coolant port to extend from the battery system inside the battery pack enclosure to outside the battery pack enclosure; and a coolant line connector to connect to the coolant port outside the battery pack enclosure, the coolant line connector including: an injection molded member extending from outside of the battery pack enclosure to inside of the battery pack enclosure, the injection molded member extending in an inside of the coolant port.

### CROSS-REFERENCE TO RELATED APPLICATION(S)

This application claims the benefit of priority to U.S. Provisional Patent Application No. 63/794,900, filed Apr. 25, 2025, the entirety of which is incorporated by reference herein.

### TECHNICAL FIELD

Various embodiments of the present disclosure relate generally to leak management and, more particularly, to coolant connections for leak management for battery packs for electric vehicles.

### BACKGROUND

Batteries are increasingly being integrated into a wide range of mobile devices, including smartphones, laptops, electric vehicles (EVs), hybrid electric vehicles (HEVs), plug-in hybrid electric vehicles (PHEVs), and energy storage systems (ESS). The batteries may be included in a battery system with a battery housing. The battery housing may contain various components, such as battery cells, a battery cooling plate assembly, one or more sensors, and a controller.

Battery modules of a battery may be stacked with cooling plates in a battery assembly system. However, components of the battery may limit the cost or ease of manufacturing a battery assembly system. Furthermore, some components may increase risk of coolant leaks inside battery modules.

The present disclosure is directed to overcoming one or more of these above-referenced challenges.

### SUMMARY OF THE DISCLOSURE

In some aspects, the techniques described herein relate to a system including: a battery pack enclosure to enclose a battery system; a coolant port to extend from the battery system inside the battery pack enclosure to outside the battery pack enclosure; and a coolant line connector to connect to the coolant port outside the battery pack enclosure, the coolant line connector including: an injection molded member extending from outside of the battery pack enclosure to inside of the battery pack enclosure, the injection molded member extending in an inside of the coolant port.

In some aspects, the techniques described herein relate to a system further including: a coolant line to connect with the coolant line connector.

In some aspects, the techniques described herein relate to a system, wherein the battery system includes: one or more battery modules, and one or more electrical components.

In some aspects, the techniques described herein relate to a system, wherein the battery system includes one or more cooling plates.

In some aspects, the techniques described herein relate to a system, wherein the coolant port is configured to connect to one or more cooling plates inside the battery pack enclosure.

In some aspects, the techniques described herein relate to a system, wherein the coolant line connector further includes: a quick connect fitting.

In some aspects, the techniques described herein relate to a system, further including: a second coolant port configured to extend outside the battery pack enclosure, and wherein the coolant line connector is configured to connect to the second coolant port outside the battery pack enclosure.

In some aspects, the techniques described herein relate to a system, further including: the battery system, wherein the battery system includes: one or more battery modules, and one or more electrical components.

In some aspects, the techniques described herein relate to a system, wherein the coolant port is metal.

In some aspects, the techniques described herein relate to a system, wherein the coolant port is cast aluminum.

In some aspects, the techniques described herein relate to a system, wherein the coolant line connector is plastic.

In some aspects, the techniques described herein relate to a system, wherein the coolant line connector is PA66 plastic.

In some aspects, the techniques described herein relate to a cooling system for a battery pack, the cooling system including: one or more cooling plates to cool one or more battery modules; a first coolant port connected to the one or more cooling plates; a second coolant port connected to the one or more cooling plates, wherein the first coolant port and the second coolant port are configured to extend outside of the battery pack; and a coolant line connector connected to the first coolant port and the second coolant port.

In some aspects, the techniques described herein relate to a cooling system, wherein: the one or more cooling plates include a first cooling plate and a second cooling plate, and the first coolant port is welded to the first cooling plate, and the second coolant port is welded to the second cooling plate.

In some aspects, the techniques described herein relate to a cooling system, further including double O-rings disposed in the first coolant port to provide leak-tight operation under pressure and thermal cycling.

In some aspects, the techniques described herein relate to a cooling system, further including double O-rings disposed in the coolant line connector to provide leak-tight operation under pressure and thermal cycling.

In some aspects, the techniques described herein relate to a cooling system, further including: the battery pack; one or more quick connector joints; one or more O-ring seal joints; and one or more barbed tube joints, wherein the one or more quick connector joints, the one or more O-ring seal joints, and the one or more barbed tube joints are connected to the cooling system outside the battery pack.

In some aspects, the techniques described herein relate to a system including: a metal coolant port connected to a cooling plate, wherein the metal coolant port is configured to extend outside of a battery pack; and a plastic coolant line connector connected to the metal coolant port.

In some aspects, the techniques described herein relate to a system, wherein an opening of a connection between the plastic coolant line connector and the metal coolant port is located outside the battery pack so that any leakage of coolant from the connection is directed outside the battery pack.

In some aspects, the techniques described herein relate to a system, wherein the plastic coolant line connector is disposed in a cover of the battery pack.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure for a vehicle including a battery, according to one or more embodiments.

FIG. 2 depicts an exemplary system infrastructure for a battery with a controller, according to one or more embodiments.

FIG. 3 depicts a diagram of a coolant connection for externalized leak management, according to one or more embodiments.

FIG. 4 depicts a side view of a coolant connection for externalized leak management in a battery module, according to one or more embodiments.

FIG. 5 depicts a cross sectional view of a coolant connection for externalized leak management in a battery module, according to one or more embodiments.

FIG. 6 depicts a cross sectional view of a coolant connection for externalized leak management, according to one or more embodiments.

FIG. 7 depicts a coolant connection for externalized leak management in a battery pack, according to one or more embodiments.

### DETAILED DESCRIPTION OF EMBODIMENTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Various embodiments of the present disclosure relate generally to leak management and, more particularly, to coolant connections for leak management for battery packs for electric vehicles.

One or more embodiments may provide a coolant connection design that ensures that all potential leak points are located outside the battery pack enclosure. Battery systems may typically use quick connectors inside the pack to link coolant hoses and cooling plates; if these joints fail, coolant may leak directly into the pack, and may put cells and electronics at serious risk of damage. One or more embodiments may prevent leaks directly into the pack by relocating the coolant joint externally, so any leakage happens safely outside the pack. Relocating the coolant joint externally may eliminate the possibility of exposing battery cells or electrical components to coolant and may delay cooling system failure during a thermal propagation event by eliminating soft joints (e.g., rubber sealing, which is a subsystem of a quick connector, and plastic quick connectors that melt before aluminum), including situations where there is no structural crack or rupture. One or more embodiments may provide a safer, smarter solution for thermal management in electric vehicles.

Cooling may be important in electric vehicle batteries, and some systems may use quick connectors inside the pack to join coolant pipes. While these connectors may make assembly easier, they may leak over time. When quick connectors leak over time, coolant may enter the pack and may damage electrical components such as battery cells or circuit boards. This leaking and damage may create major safety and maintenance challenges. One or more embodiments may provide a design that may provide coolant joints such as quick connector joints, coolant O-ring seal joints, and barbed tube joints outside the battery pack to address problems related to leaking.

Some technical problems with battery packs include the internal placement of coolant connectors within conventional sealed battery packs. These connectors, especially quick-connect types, may be prone to wear, thermal stress, or assembly tolerance issues that can cause leakage over time. Once compromised, some quick-connect types may allow coolant to enter the pack, damaging components, and may cause isolation issues and may result in early failure of maintaining coolant flow during thermal propagation events. For some systems, pack internal coolant leakage detection may not detect leaks before damage occurs, and repairs may be costly or difficult without full disassembly. One or more embodiments may provide a system to externalize leakage risk.

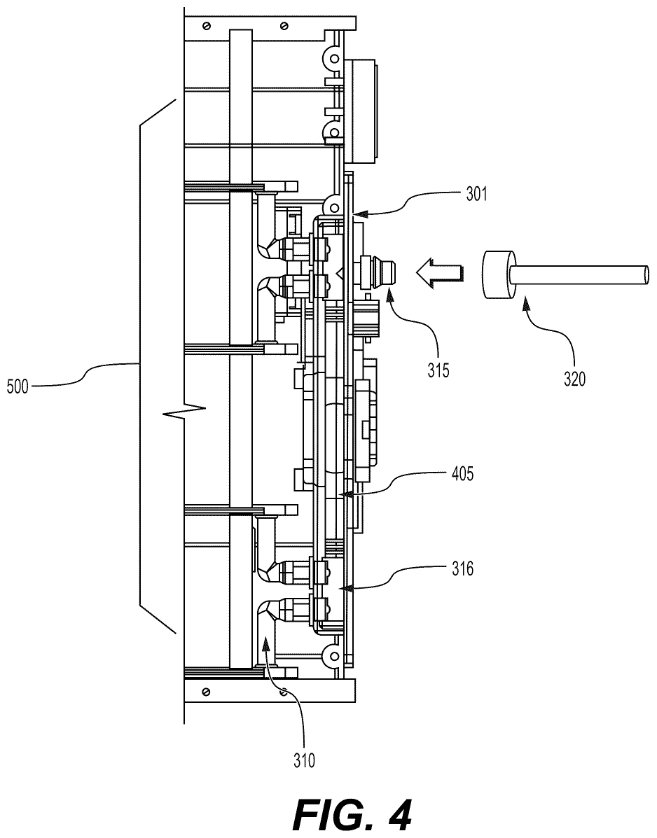

One or more embodiments may address coolant leakage risks by relocating the coolant connection joint to the external cover surface (see, e.g., FIG. 4). An aluminum (“AI”) coolant port may be welded directly to the cooling plate, reducing leakage risk at that interface. As the port passes through the cover, the port may be sealed with an IP-rated design, maintaining environmental protection and internal isolation. The external injection molding plastic or AI die casting connector may be coupled to the spigot using double O-rings, providing leak-tight operation under pressure and thermal cycling (see, e.g., FIG. 4). One or more embodiments may provide a setup which creates a layered defense system that provides all potential leakage is contained externally, away from cells and electrical (“EE”) components.

One or more embodiments may provide coolant connection architecture by relocating the connection joint from inside the battery pack to the external interface surface. Unlike some systems that may rely on internal quick connectors within the sealed enclosure, one or more embodiments may provide a design that may allow all fluid connections and potential failure points to exist entirely outside the battery pack. The shift from internal leaks to external leaks not only may simplify the internal cooling layout but also may reduce coolant exposure risk to battery and electronic components. The coolant connection architecture provided herein may transform coolant connections from an embedded system vulnerability into an externally manageable and serviceable interface. One or more embodiments may provide, for example, a safer, cleaner, and more resilient thermal design strategy.

Some systems may attempt to manage coolant leakage risk through early detection or compartmentalized containment within the pack. Some designs may attempt to improve the reliability of internal quick connectors with better materials, sealing geometries, or assembly techniques. However, some system strategies may still rely on internal failure mitigation rather than external failure isolation. One or more embodiments may provide a leak management design by removing the risk from the interior entirely, and not merely managing it.

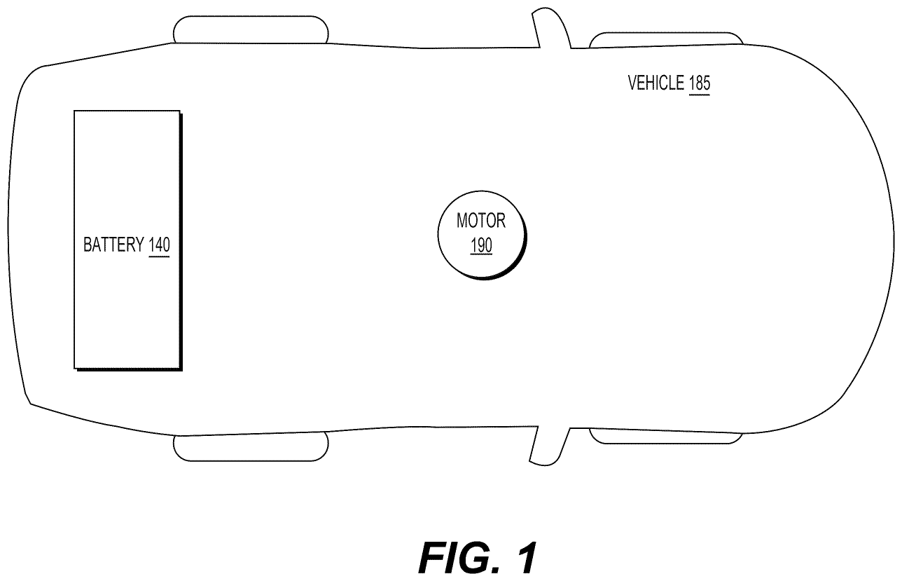

FIG. 1 depicts an exemplary system infrastructure for a vehicle including a battery, according to one or more embodiments. As shown in FIG. 1, vehicle 185 may include a motor 190, and a battery 140. Battery 140 may be a battery pack. Battery 140 may include one or more battery modules. Battery 140 may include individual battery cells, and a controller configured to control either a charging of the battery 140 or a discharging of the battery 140. The controller may include a battery management system (“BMS”) to control and monitor the battery's status during one or more charging or discharging operations. The battery 140 may provide electrical power to a motor 190. Vehicle 185 may include diesel powered vehicles, gasoline powered vehicles, hydrogen powered vehicles, electric powered vehicles, or hybrid vehicles.

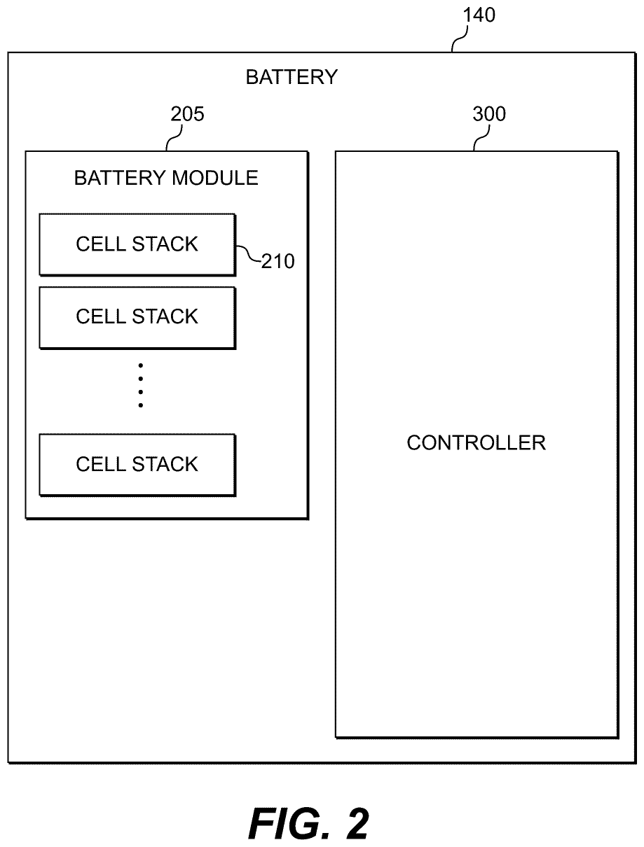

FIG. 2 depicts an exemplary system infrastructure for a battery with a controller, according to one or more embodiments. Battery 140 may include a battery module 205 and controller 300. The controller 300 may include a battery management system (“BMS”) to control and monitor the battery's status during one or more charging or discharging operations. Battery module 205 may include a plurality of cell stacks, including cell stack 210.

Battery 140 may include a battery pack. Battery 140 may include an overcharge prevention apparatus. Overcharge prevention apparatus may include a voltage measuring unit, a current regulating unit, and a controller 300, and optionally may further include at least one of a disconnecting unit, a current measuring unit, and a cooling unit. Additionally, when the overcharge prevention apparatus includes a disconnecting unit, a discharge inducing unit may be included.

The plurality of cell stacks, which may include cell stack 210, may be connected in series and installed on a high current path between two power terminals of battery 140. A voltage measuring unit may measure the voltage of each cell stack 210 and may generate a first monitoring signal indicating the measured voltage. The first monitoring signal generated by the voltage measuring unit may be transmitted to the controller. The current regulating unit may be configured to selectively provide each cell stack 210 with bypass paths connected in parallel. Current regulating units may provide bypass paths individually to the plurality of cell stacks, which may include for example cell stack 210.

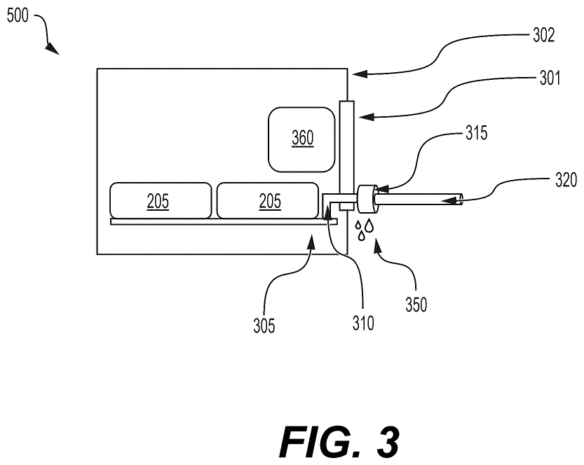

FIG. 3 depicts a diagram of a coolant connection for externalized leak management, according to one or more embodiments. Battery assembly 500 may include box cover 301 and battery pack enclosure 302. Battery pack enclosure 302 may enclose a battery system including battery module 205, electronic components 360, and cooling plate 305. Box cover 301 may include coolant port 310 and connector 315. Coolant port 310 and connector 315 may be separate from box cover 301, or one may be connected to box cover 301 while the other component is not connected to box cover 301. For example, connector 315 may be disposed in box cover 301 while coolant port 310 is not disposed within box cover 301, and coolant port 310 connected to cooling plate 305. Connector 315 may be a coolant line connector. For example, connector 315 may be fluidically connected to supply or discharge line 320.

Coolant port 310 may extend from inside the battery pack enclosure 302 to outside the battery pack enclosure 302. For example, coolant port 310 may connect from cooling plate 305 to outside of battery pack enclosure 302 through box cover 301. Coolant port 310 may be metal, such as cast aluminum, for example. Coolant port 310 may be welded to another component of battery assembly 500. For example, coolant port 310 may be welded to cooling plate 305. Connector 315 may be an injection molded member extending from outside of the battery pack enclosure 302 to inside of the battery pack enclosure 302, the connector 315 extending into an inside of the coolant port 310. Connector 315 may be plastic, such as PA66 plastic, for example. Connector 315 may include a quick connect fitting.

Coolant port 310 and connector 315 may mate together to form a seal between the two components to allow a flow of fluid, such as coolant, through the two components. An opening of a connection between the coolant port 310 and connector 315 may be located outside of battery assembly 500, box cover 301, or battery pack enclosure 302. The opening of the connection between the coolant port 310 and connector 315 may be located such that any leakage of coolant from the connection is directed outside of the battery assembly 500. The opening of the connection between the coolant port 310 and connector 315 may be disposed on an opening plate of the battery pack enclosure 302. For example, the opening of the connection between the coolant port 310 and connector 315 may be disposed on or in box cover 301. The connection between the coolant port 310 and connector 315 may include one or more quick connector joints, one or more O-ring seal joints, or one or more barbed tube joints.

FIG. 4 depicts a side view of a coolant connection for externalized leak management in a battery module, according to one or more embodiments. Battery assembly 500 may include box cover 301. Box cover 301 may include connector 315, second connector 316, coolant port 310, and coolant line 405. For example, coolant port 310 may extend from inside of battery assembly 500 through box cover 301 to outside of battery assembly 500, where coolant port 310 may mate with connector 315 or second connector 316. Coolant line 405 may connect connector 315 to a second connector 316. Connector 315 may connect to supply or discharge line 320. Second connector 316 may only connect to coolant port 310 and coolant line 405, and not connect to supply or discharge line 320. Box cover 301 may be removed for access to the inside of battery assembly 500. Coolant line 405 may be metal or plastic.

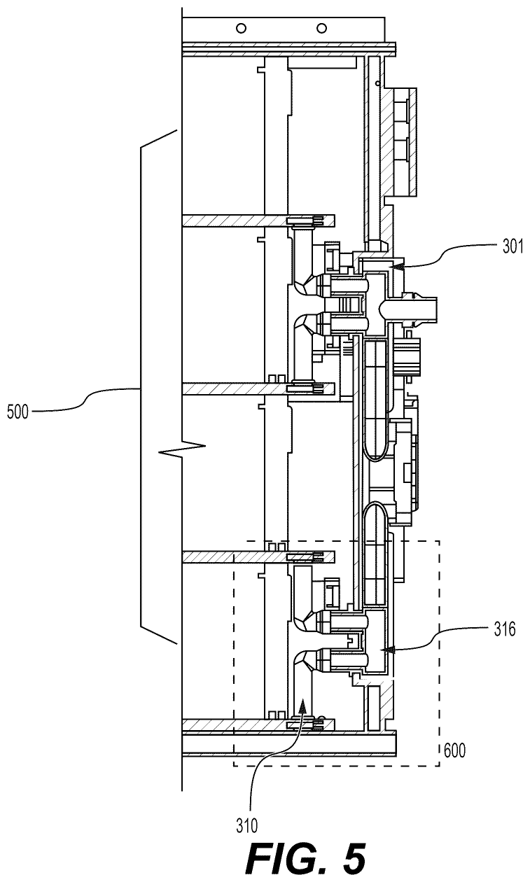

FIG. 5 depicts a cross sectional view of a coolant connection for externalized leak management in a battery module, according to one or more embodiments. Battery assembly 500 may include box cover 301. Box cover 301 may include system 600. System 600 may include coolant port 310 and second connector 316.

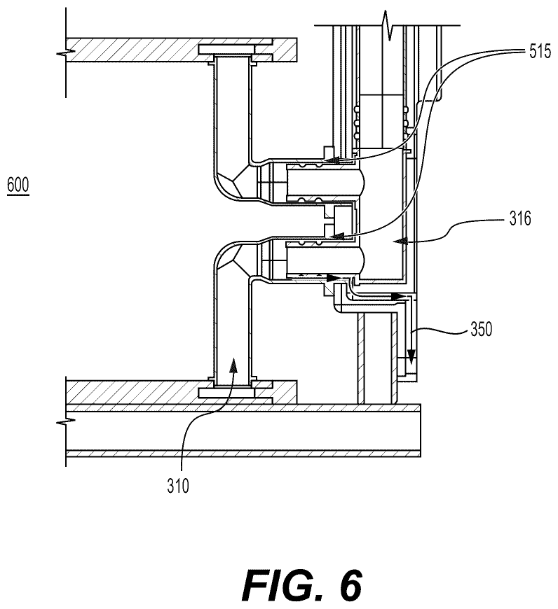

FIG. 6 depicts a cross sectional view of a coolant connection for externalized leak management, according to one or more embodiments. System 600 may include coolant port 310 and second connector 316. Coolant port 310 and second connector 316 may mate together to form a connection between the two components and may allow a flow of fluid, such as coolant, through the two components. The connection between coolant port 310 and second connector 316 may include leakage protection 515. Leakage protection 515 may include double O-rings, for example. An opening of a connection between the coolant port 310 and second connector 316 may be located outside a battery, for example, battery assembly 500, box cover 301, or battery pack enclosure 302. The opening of the connection between the coolant port 310 and second connector 316 may be located such that any leakage of coolant from the connection is directed in a path, for example, leakage path 350 to an outside of box cover 301.

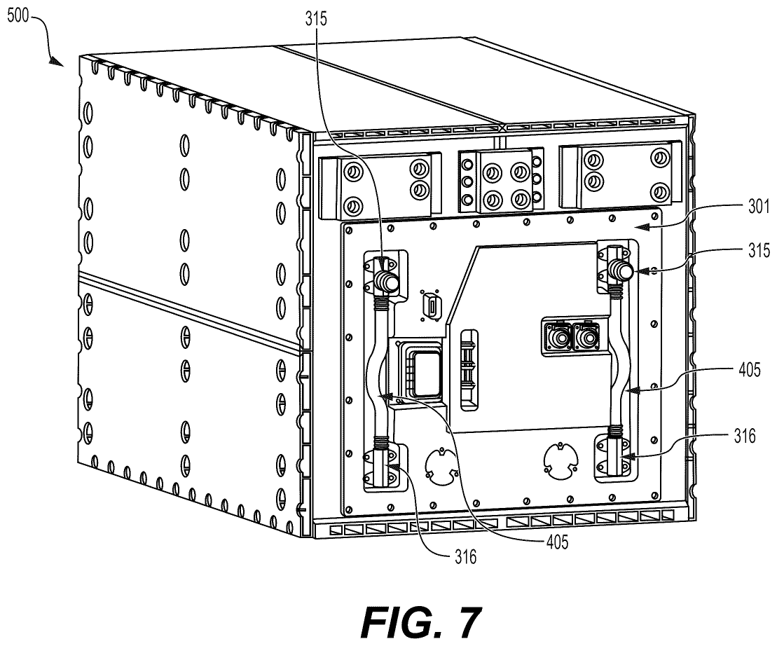

FIG. 7 depicts a coolant connection for externalized leak management in a battery pack, according to one or more embodiments. Battery assembly 500 may include box cover 301. Box cover 301 may include (first) connector 315, second connector 316, coolant port 310, and coolant line 405. Coolant line 405 may connect (first) connector 315 to second connector 316. Battery assembly 500 may be installed in a vehicle 185, for example (e.g., battery 140).

One or more embodiments may enable a coolant circulation longer than conventional quick connector soft joints by using aluminum hard joints inside of a battery pack, which may also have a significant impact on further delaying thermal propagation.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system comprising:
a battery pack enclosure to enclose a battery system;
a coolant port to extend from the battery system inside the battery pack enclosure to outside the battery pack enclosure; and
a coolant line connector to connect to the coolant port outside the battery pack enclosure, the coolant line connector including:
an injection molded member extending from outside of the battery pack enclosure to inside of the battery pack enclosure, the injection molded member extending in an inside of the coolant port.

2. The system of claim 1 further including:
a coolant line to connect with the coolant line connector.

3. The system of claim 1, wherein the battery system includes:
one or more battery modules, and
one or more electrical components.

4. The system of claim 1, wherein the battery system includes one or more cooling plates.

5. The system of claim 1, wherein the coolant port is configured to connect to one or more cooling plates inside the battery pack enclosure.

6. The system of claim 1, wherein the coolant line connector further includes:
a quick connect fitting.

7. The system of claim 1, further comprising:
a second coolant port configured to extend outside the battery pack enclosure, and wherein the coolant line connector is configured to connect to the second coolant port outside the battery pack enclosure.

8. The system of claim 1, further comprising:
the battery system, wherein the battery system includes:
one or more battery modules, and
one or more electrical components.

9. The system of claim 1, wherein the coolant port is metal.

10. The system of claim 9, wherein the coolant port is cast aluminum.

11. The system of claim 1, wherein the coolant line connector is plastic.

12. The system of claim 11, wherein the coolant line connector is PA66 plastic.

13. A cooling system for a battery pack, the cooling system including:
one or more cooling plates to cool one or more battery modules;
a first coolant port connected to the one or more cooling plates;
a second coolant port connected to the one or more cooling plates, wherein the first coolant port and the second coolant port are configured to extend outside of the battery pack; and
a coolant line connector connected to the first coolant port and the second coolant port.

14. The cooling system of claim 13, wherein:
the one or more cooling plates include a first cooling plate and a second cooling plate, and
the first coolant port is welded to the first cooling plate, and the second coolant port is welded to the second cooling plate.

15. The cooling system of claim 13, further including double O-rings disposed in the first coolant port to provide leak-tight operation under pressure and thermal cycling.

16. The cooling system of claim 13, further including double O-rings disposed in the coolant line connector to provide leak-tight operation under pressure and thermal cycling.

17. The cooling system of claim 13, further including:
the battery pack;
one or more quick connector joints;
one or more O-ring seal joints; and
one or more barbed tube joints,
wherein the one or more quick connector joints, the one or more O-ring seal joints, and the one or more barbed tube joints are connected to the cooling system outside the battery pack.

18. A system comprising:
a metal coolant port connected to a cooling plate, wherein the metal coolant port is configured to extend outside of a battery pack; and
a plastic coolant line connector connected to the metal coolant port.

19. The system of claim 18, wherein an opening of a connection between the plastic coolant line connector and the metal coolant port is located outside the battery pack so that any leakage of coolant from the connection is directed outside the battery pack.

20. The system of claim 19, wherein the plastic coolant line connector is disposed in a cover of the battery pack.
